(19) United States
(12) Patent Application Publication
(10) Pub. No.: US 2023/0214624 A1
(43) Pub. Date: Jul. 6, 2023

(54) SANITARY INSERT, METHOD FOR PRODUCING A SANITARY INSERT, METHOD FOR IDENTIFYING A PRODUCT FORM OF A SANITARY INSERT AND COMPUTER PROGRAM PRODUCT

(71) Applicant: Neoperl GmbH, Müllheim (DE)

(72) Inventors: David BIRMELIN, Müllheim (DE); Holger SCHÜRLE, Müllheim (DE); Alexander STEIN, Ihringen (DE); Alexandra WELZ, Neuenberg (DE); Christoph WEIS, Müllheim (DE)

(73) Assignee: Neoperl GmbH, Müllheim (DE)

(21) Appl. No.: 17/927,996

(22) PCT Filed: May 27, 2021
(86) PCT No.: PCT/EP2021/064305

§ 371 Date: Nov. 28, 2022

(30) Foreign Application Priority Data
Jun. 3, 2020 (DE) 202020103196.1

(51) Int. Cl. G06K 19/06; E03C 1/08

(52) U.S. Cl. CPC G06K 19/06037; E03C 1/08; E03C 2201/00

(57) ABSTRACT

A sanitary insert (1) having a housing (2), in which at least one functional unit (3) is arranged, having an outlet side (4), which is formed by an outlet structure (5), the sanitary insert (1) having at least one identifier (6) by which a product form of the sanitary insert (1) can be identified.

### TECHNICAL FIELD

The invention relates to a sanitary insert. The invention relates in particular to a sanitary insert configured as a jet regulator. The sanitary insert comprises a housing, in which at least one functional unit is arranged, and an outlet side, which is formed by an outlet structure. In particular, when the sanitary insert is in an installed state in a sanitary fitting, the outlet side may be externally visible to a user.

The invention furthermore relates to a method for producing a sanitary insert, and to a method for identifying a product form of a sanitary insert, and to a computer program product, a device for data processing, and a computer-readable memory medium.

### BACKGROUND

Sanitary inserts of the type mentioned in the introduction are used for example in the sanitary sector. Such sanitary inserts can become worn over time as a result of their use or become contaminated over time. This can then lead to functional limitations, in particular of the functional unit. In general, sanitary inserts have standardized sizes, such that it is not or scarcely possible to determine a particular type of a sanitary insert solely on the basis of the dimensions. It is therefore often very difficult for a user to find a suitable replacement part for a defective or used sanitary insert, which in particular has the same functional unit.

### SUMMARY

It is therefore the object to make it easier for a user to identify a particular product form of a sanitary insert.

Said object is achieved by a sanitary insert having one or more of the features disclosed herein.

In particular, according to the invention, to achieve the object, a sanitary insert of the type mentioned in the introduction is proposed, which is furthermore characterized in that the sanitary insert has at least one discernible identifier by means of which a product form of the sanitary insert, in particular at least of the functional unit of the sanitary insert, can be identified. The identifier may preferably be designed to be optically discernible.

The refinement according to the invention therefore has the advantage that a user without expert knowledge of the insert that is to be replaced can carry out an exchange for a structurally identical new insert. Conventional sanitary inserts are designed such that, on the insert in the installed situation, a user cannot identify any specific features that indicate a particular product form. By contrast, the sanitary insert according to the invention now offers the possibility of identifying the product form, preferably without the need to uninstall the sanitary insert, for example in order to have to compare a serial number that is printed onto the side of the housing. It is generally also the case that a defective sanitary insert does not lose functionality suddenly, but the user initially notices limitations in functionality. If the user were to uninstall the sanitary insert at this stage, the user would then have to temporarily operate the fitting outlet without a sanitary insert until they have procured a replacement. With the identifier according to the invention, it is thus possible to firstly identify the product form, procure a replacement, and only then perform an exchange of the defective sanitary insert.

The expression “product form” may relate for example to an exactly structurally identical type of sanitary insert and/or to a product category, for example in the case of “water-saving” or “non-water-saving” jet regulators.

Advantageous refinements of the invention will be described below, which refinements may individually, or in combination with the features of other refinements, be optionally combined with the features noted above.

In one advantageous refinement, the sanitary insert may have at least two identifier elements which are adjustable relative to one another, in particular through a rotational angle, and/or are fixable in position relative to one another. Here, a fixing may be understood in particular to mean a permanent establishment, that is to say an establishment which is unalterable for example during the intended use of the insert, of the relative position of the identifier elements that are adjustable with respect to one another.

In particular, the sanitary insert may have at least two identifier rings and/or at least one housing part and/or at least one screen and/or at least two housing parts as identifier elements. A specific identifier may be settable or set by setting a particular position of the two identifier elements with respect to one another. It is thus easily possible for a user, on the basis of the set specific identifier, to uniquely assign the product form or identify a structurally identical replacement insert. The relative fixing of the identifier elements may be achieved for example by overmolding or clipping-on or plugging-in or detent engagement or the like. A specific characteristic of the fixing may be that, when the sanitary insert is in the intended position of use, said fixing is no longer alterable, or must not be altered at least during operation (the former variant being more preferable for the sake of certainty of identification).

The at least two identifier elements may thus be adjustable relative to one another, during the production of the insert and/or subsequently, into a setting position that characterizes the insert or a particular product form thereof. Furthermore, the identifier elements may be permanently fixable (cf. above) in the setting position thus set. It can thus be achieved in particular that the setting position is unalterable, and thus allows unique identification of the insert, when the insert is an intended position of use.

So as not to adversely affect the overall impression during normal operation, it is possible in one advantageous refinement that the sanitary insert has an identifier object which can be removed or pivoted out from the housing and/or from the outlet side and which has the at least one identifier. It can be particularly advantageous here that a user can remove the identifier object or can transfer the identifier depicted on the identifier object onto a notepad or the like, in order to subsequently procure a replacement specialist retailer, the user being able to take the removed identifier object or the notepad with them independently of the insert, which remains installed.

In order to be able to avoid the need for uninstallation for the purposes of identifying and/or pivoting out or removing an object that has the identifier, it is possible in one advantageous refinement that the at least one identifier is arranged such that the at least one identifier can be detected when the sanitary insert is in the installed state in a sanitary fitting. In particular, the at least one identifier may be detectable, in particular readable, at the outlet side. The sanitary insert preferably remains functional during the detection of the at least one identifier.

In one advantageous refinement, the at least one identifier may be formed by at least one plug-in element. In particular, the at least one plug-in element may be plugged onto and/or into the output structure and/or into the housing and/or a screen. A pattern that forms the at least one identifier can preferably be formed by means of multiple plug-in elements. A multiplicity of different specific identifiers can thus be easily be formed.

In one particularly advantageous refinement, the sanitary insert may have a transponder in which the at least one identifier is stored, the at least one identifier being readable using a read unit, preferably an external read unit. In particular, the at least one identifier may be electronically and/or contactlessly readable. For example, the transponder may be configured as an RFID transponder and/or NFC chip. Particularly easy identification of the product form of the sanitary insert is thus possible, because a user does not even need a clear view of the outlet side of the sanitary insert in order to visually read an identifier. Rather, a unique identification is possible using a suitable read unit, which may for example be made available in static form in, or for loan from, a hardware store.

In a further advantageous refinement, the at least one identifier may be formed as a two-dimensional and/or three-dimensional code. For example, the at least one identifier may be formed as a QR code and/or as clear text and/or as a height profile (in particular as a height relief composed of elevations protruding from the outlet side, and depressions between the elevations). It may be particularly advantageous if the height profile is formed at the edge of the outlet side. It is thus possible for the product form of the insert to be identified by identification of the two-dimensional and/or three-dimensional code.

In one particularly advantageous refinement, the at least one identifier may be arranged and/or formed on one of the following structures, or on a combination of two or more of the following structures, of the sanitary insert: outlet side, in particular as a pattern of fillings of the passage openings of the outlet structure, upstream screen, in particular fillings of the screen openings, mouth piece, seal, housing, in particular on a lateral surface of the housing.

The above-stated object is achieved according to the invention by means of the method, claimed with the coordinate claim, for producing a sanitary insert. In particular, here, a sanitary insert according to the invention as described and/or claimed herein may be produced by means of the method.

In particular, to achieve the above-stated object, provision may be made for a sanitary insert having at least one preferably optically or magnetically discernible identifier for identifying a product form of the sanitary insert to be produced, wherein, to form the identifier, at least two identifier elements which are adjustable relative to one another are adjusted, in particular through a rotational angle, and the identifier elements are fixed relative to one another in the set position. The identifier may also be optically and magnetically readable.

It is preferable here if said fixing causes a setting position that characterizes the insert or a particular product form to be permanently established. This may in particular be performed such that the insert can then be uniquely identified when the insert is in an intended position of use. The insert can thus be identified particularly easily, in particular without uninstallation from a fitting.

Here, a fixing may be understood in particular to mean a permanent establishment, that is to say an establishment which is unalterable for example during the intended use of the insert, of the relative position of the identifier elements that are adjustable with respect to one another. It is thus ensured that the insert can in all situations be reproducibly identified on the basis of the relative setting position, once it has been fixed, between the at least two identifiers. This characteristic of being permanently fixable in the setting position thus distinguishes the identifier elements according to the invention from setting rings or the like known in the prior art, which are adjusted by the user during intended use for example for the purposes of setting/varying a throughflow volume through the insert or some other variable.

In a dedicated design variant according to the invention which, in one advantageous refinement, is also combinable with the above-stated embodiment of the method, it is possible that, to form the at least one identifier, at least one plug-in element is plugged into the housing and/or an outlet structure and/or a screen, preferably that a pattern composed of multiple plug-in elements is plugged in.

In a further possible refinement of the invention, the sanitary insert may have at least one magnetically readable identifier by means of which a product form of the sanitary insert can be identified. An advantage of this is in particular that the identifier specifically does not need to be externally discernible, allowing greater freedom for the configuration of the product with regard to the design of the insert (the surface of the insert then no longer needs to form the identifier; rather, the identifier can be placed in a concealed position in the interior of the insert).

The invention furthermore relates to a method for identifying a product form of a sanitary insert, with which method the above-stated object can be achieved. Here, the insert may preferably be designed or produced as described above, or in accordance with any one of the claims that are directed to such an insert or to a method for producing such an insert.

This identification method may preferably take the form of a computer-implemented method, in particular such that all method steps are executed in computer-implemented form.

According to the invention, in the case of this method, it is possible in particular that at least one preferably optically and/or magnetically discernible identifier, assigned to the product form, on the sanitary insert is acquired, in particular detected, that the detected at least one identifier is assigned to the product form on the basis of an identifier list, preferably on the basis of an identifier list stored in a database, and that, as a result, the product form is output and/or the insert is sorted in accordance with its product form. The resulting advantages have already been discussed with regard to the sanitary insert, and apply analogously to the method described and/or claimed herein.

In one advantageous refinement, provision may be made for an identifier object which has the at least one preferably optically and/or magnetically discernible identifier to be removed or pivoted out from the housing and/or from the outlet side, and for the identifier on the identifier object to be identified.

In order to make the identification particularly easy for a user, for example by virtue of the fact that read errors can be avoided, it is possible for the at least one identifier to be machine-readable. For example, the at least one identifier may be coded on the identifier object so as to be machine-readable by feature and/or shape recognition.

In one particularly advantageous refinement, an identification method or a combination of at least two identification methods selected from optical detection (color coding), near-field communication, haptic detection, detection by positive engagement, magnetic detection and electromagnetic detection may be used for detecting the identifier.

In a further advantageous refinement, the at least one identifier may be acquired by taking a negative molding, the negative in particular being compared with an identifier list that comprises positives. A user without specific expert knowledge can thus easily identify the product form, with read errors being avoided or ruled out entirely.

Alternatively, the at least one identifier may be acquired through the use of a provided negative. For example, this negative may be included in a shipment, in particular separately from or connected detachably or severably to the insert. A detection tool is thus provided that can be used for identifying a structurally identical replacement insert. In particular, the negative may in this case be compared with an identifier list that comprises positives.

In a further possible refinement of the above identification method, said identifier, which is formed on or in the sanitary insert, may also be magnetically read (either in addition or as an alternative to optical or mechanical reading). For this purpose, corresponding magnetic field sensors may be used which detect a magnetic field of the identifier, this being possible even if the identifier is concealed in the insert so as not to be visible from the outside.

The invention furthermore relates to a computer program product, comprising commands which, when the program is executed by a computer, cause said computer to carry out the method as described and/or claimed herein.

The invention furthermore relates to a device for data processing, comprising means for carrying out the steps of the method as described and/or claimed herein.

The invention finally relates to a computer-readable memory medium, comprising commands which, when executed by a computer, cause said computer to carry out the method as described and/or claimed herein.

### BRIEF DESCRIPTION OF THE DRAWINGS

The invention will now be described in more detail on the basis of several exemplary embodiments, but is not limited to these exemplary embodiments. Further exemplary embodiments will emerge from the combination of the features of individual or several claims with one another and/or with individual or several features of the exemplary embodiments.

In the Figures:

FIG. 1 shows a first possible design variant of a sanitary insert according to the invention, the sanitary insert having at least two identifier rings which are adjustable relative to one another through an angle of rotation and/or are fixable in position relative to one another,

FIG. 2 shows a second possible design variant of a sanitary insert according to the invention, the sanitary insert having an identifier in the form of a number of depressions on the outer side of the housing, each product form being assigned a different identifier, in particular a different number of depressions,

FIG. 3 shows a third possible design variant of a sanitary insert according to the invention, the sanitary insert having an identifier in the form of a number of protuberances and/or material accumulations on the outer side of the housing, each product form being assigned a different identifier, in particular a different number of protuberances and/or material accumulations,

FIG. 4 shows a fourth possible design variant of a sanitary insert according to the invention, the sanitary insert having an identifier in the form of a number and/or a pattern of identifier elements that can be plugged into the outlet side, each product form being assigned a different identifier, in particular a different number and/or a different pattern of identifier elements,

FIG. 5 shows a fifth possible design variant of a sanitary insert according to the invention, the sanitary insert having an identifier in the form of a number of identifier elements that can be plugged into a side wall of the housing, each product form being assigned a different identifier, in particular a different number and/or a different pattern of identifier elements,

FIG. 6 shows a sixth possible design variant of a sanitary insert according to the invention, the sanitary insert having an identifier in the form of a number and/or a pattern of preferably two-dimensional identifier elements formed and/or implemented by coloring in the outlet side, each product form being assigned a different identifier, in particular a different number and/or a different pattern of identifier elements,

FIG. 7 shows a seventh possible design variant of a sanitary insert according to the invention, the sanitary insert having an identifier in the form of a number and/or a pattern and/or a size of filled areas in the outlet side, each product form being assigned a different identifier, in particular a different number and/or a different pattern and/or a different size of filled areas,

FIG. 8 shows an eighth possible design variant of a sanitary insert according to the invention, the sanitary insert having an identifier in the form of a number and/or a pattern of preferably three-dimensional identifier elements formed and/or implemented by coloring in the outlet side, each product form being assigned a different identifier, in particular a different number and/or a different pattern of identifier elements,

FIG. 9 shows a ninth possible design variant of a sanitary insert according to the invention, the sanitary insert having an identifier in the form of a number and/or a pattern and/or a size of filled areas in the outlet side, each product form being assigned a different identifier, in particular a different number and/or a different pattern and/or a different size of filled areas,

FIG. 10 shows a possible design variant of a method according to the invention for identifying a product form of a sanitary insert according to the invention, with a molding being taken to create a negative, or a matching negative being used, with an attempt being made to insert a new sanitary insert in order to be able to test whether the new insert corresponds in terms of product form to the old insert,

FIG. 11 shows a further possible design variant of a method according to the invention for identifying a product form of a sanitary insert according to the invention, with a molding being taken to create a negative, or a matching negative being used, with an attempt being made to insert a new sanitary insert in order to be able to test whether the new insert corresponds in terms of product form to the old insert,

FIG. 12 shows a further possible design variant of a method according to the invention for identifying a product form of a sanitary insert according to the invention, with an identification by means of an electronic identifier being performed by virtue of an external analysis unit being used to read an electronic identifier, wherein the identifier may for example be formed as an NFC chip,

FIG. 13 shows a further possible design variant of a method according to the invention for identifying a product form of a sanitary insert according to the invention, with an identification by means of a graphical identifier being performed by virtue of an external analysis unit being used to read a graphical identifier, wherein the identifier may for example be formed as a two-dimensional code, in particular as a QR code,

FIG. 14 shows a further possible design variant of a method according to the invention for identifying a product form of a sanitary insert according to the invention, with an identification by means of a magnetic identifier being performed by virtue of an external analysis unit, in particular a magnet, being used to read a magnetic identifier, wherein identification is performed for example by way of an interaction between the magnet and a ferromagnetic identification element,

FIG. 15 shows a fifteenth possible design variant of a sanitary insert according to the invention, the sanitary insert having an identifier in the form of a number and/or a pattern and/or a size of identifier elements arranged and/or formed on a seal element, each product form being assigned a different identifier, in particular a different number and/or a different pattern and/or a different size of identifier elements,

FIG. 16 shows a sixteenth possible design variant of a sanitary insert according to the invention, the sanitary insert having an identifier on the outer side of a mouth piece belonging to the sanitary insert, each product form being assigned a different identifier,

FIG. 17 shows a seventeenth possible design variant of a sanitary insert according to the invention, the sanitary insert having an identifier on the outer side of a mouth piece belonging to the sanitary insert, each product form being assigned a different identifier,

FIG. 18 shows an eighteenth possible design variant of a sanitary insert according to the invention, the sanitary insert having an identifier object which can be removed and/or pivoted out from the housing and/or from the outlet side and which has the at least one identifier,

FIG. 19 shows a nineteenth possible design variant of a sanitary insert according to the invention, the sanitary insert having an identifier object which can be removed and/or pivoted out from the housing and/or from the outlet side and which has the at least one identifier,

FIG. 20 is an illustration analogous to FIG. 4, with the identifier elements being inserted from the inside or from an inlet side, and

FIG. 21 shows a further design variant of a sanitary insert according to the invention having an optically readable identifier in the form of a color coding of the outlet structure.

### DETAILED DESCRIPTION

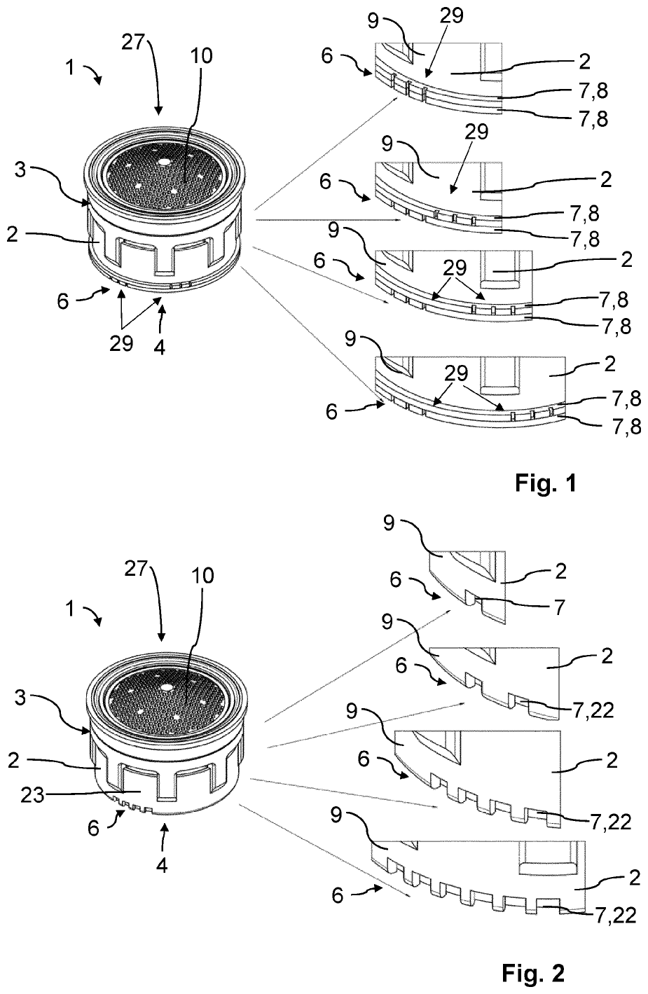

FIGS. 1-19 show multiple design variants of a sanitary insert, denoted in each case as a whole by 1.

Each sanitary insert 1 may be configured to be inserted into a water outlet of a fitting. For example, the sanitary insert may be formed as a jet regulator. A jet regulator may be configured to homogenize a water jet that emerges from a fitting.

The sanitary insert 1 has a housing 2 on which an outlet structure 5, which forms an outlet side 4 of the sanitary insert 1, is arranged and/or formed. The outlet structure 5 may for example have a honeycomb or lattice structure such that multiple mutually separate passage openings 18 are formed by the outlet structure 5.

In order to be able to identify a product form of the sanitary insert 1, all of the design variants shown in FIGS. 1-19 have in common the fact that the sanitary insert 1 has at least one identifier 6. Each identifier 6 is thus assigned to a particular product form. The invention thus also encompasses a range of multiple sanitary inserts 1 of different product forms with respectively different identifiers 6.

Using the at least one identifier 6, it is possible, without expert knowledge, to exchange a used or defective sanitary insert 1 for a new sanitary insert 1 which is structurally identical or which at least corresponds in terms of the product type. The identifier 6 specifically makes it possible to identify the sanitary insert 1 and/or at least the functional unit 3 and to find a new sanitary insert 1 with the same identifier 6 in order to replace the old one.

Functional units 3 may be regarded as units which form, define and/or aerate a water jet.

The individual design variants of the sanitary insert 1 therefore differ with regard to the nature of the identifier 6. The invention is however not limited to only the design variants shown in FIGS. 1-19.

FIG. 1 shows a design variant of the sanitary insert 1 which has two identifier elements 7 that are adjustable relative to one another through a rotational angle. The identifier elements 7 are in this case each configured as identifier rings 8, and/or as an identifier ring 8 and a housing part 9 that is adjustable relative thereto. An identifier 6 assigned to a particular product form can thus be set by way of a relative adjustment of the identifier elements 7 with respect to one another. This is achieved by virtue of the two identifier elements 7 being adjusted into a particular setting position 29 that characterizes the product form, and said setting position subsequently being permanently fixed (that is to say so as to be unalterable during the intended use of the insert).

This has the advantage that the setting position is unalterable, and thus allows the insert to be uniquely identified, when the insert is in a position of use. This is because the product form of the insert can be ascertained as soon as the setting position has been read. This may be performed in particular in computer-implemented fashion, for example by means of an app on a smartphone, which optically reads the setting position and, on the basis of a stored identifier list (stored in the app or in up-to-date form on the Internet), ascertains the product type/product form of the insert on the basis of the read setting position 29.

In the example of FIG. 1, the setting position is a relative rotational position between the two rotationally adjustable identifier elements 7. Yet further possible relative setting positions 29 will be discussed below; for example, these may also be implemented with more than just two identifier elements 7, and it would also be possible for other relative spatial adjustments of the identifier elements 7 with respect to one another to be utilized to define a characteristic setting position 29.

The two identifier elements 7 that are adjustable relative to one another may for example also have recesses, in particular notches. It is however also conceivable for the identifier 6 to be formed by other identifier elements 7 situated on the identifier rings 8.

The identifier elements 7 may furthermore be formed on a side wall 23 and/or on the outlet side 4 of the housing 2. It can thus even be possible to read the identifier 6 when the sanitary insert 1 has been inserted into a fitting, without the fitting being dismantled for this purpose.

FIG. 2 shows a design variant in which the identifier 6 is formed by material recesses 22. The identifier 6 may in this case be specified with regard to the product form through variation of the number of the material recesses 22 of different product forms. In particular, the material recesses 22 may be formed on a side wall 23 and/or on the outlet side 4 of the housing 2.

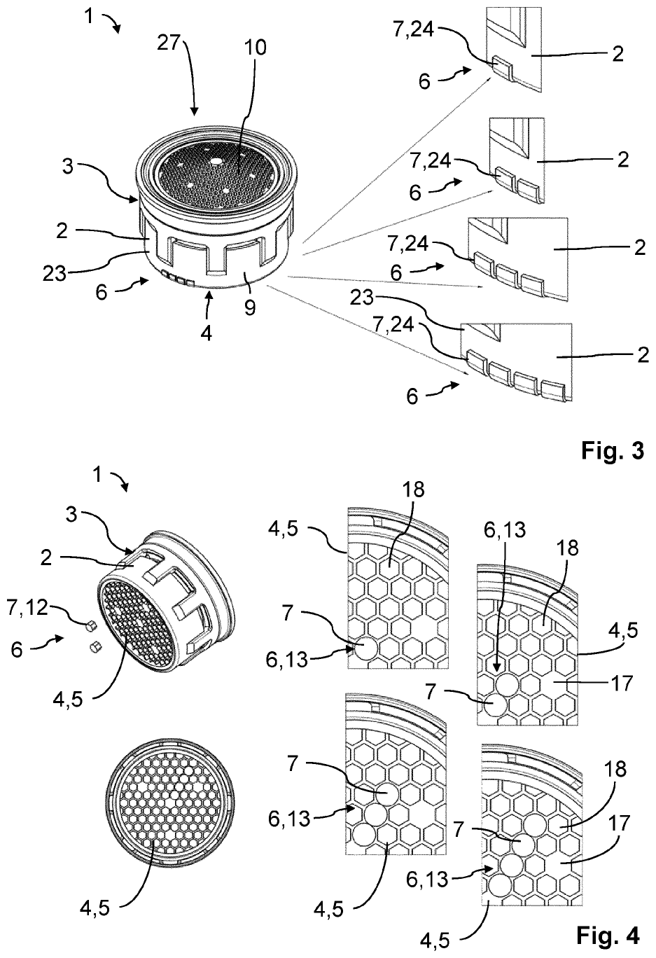

FIG. 3 shows a variant similar to the design variant from FIG. 2, with material accumulations 23 being formed here instead of material recesses 22, which material accumulations are adaptable in terms of their number in accordance with the product form, in the same way as in the design variant from FIG. 2.

FIG. 4 shows a design variant of a sanitary insert 1 in which identifier elements 7 are inserted, as plug-in elements 12, in a particular pattern 13 and/or a particular number in the outlet structure 5 in accordance with a particular product form. In particular, a plug-in element 12 can close a passage opening 18, such that a filling 17 is formed. By means of a particular arrangement of the identifier elements 7 in the outlet structure 5, an identifier 6 assignable to a particular product type can thus be formed.

Such plug-in elements 12 can thus likewise (by being inserted or not being inserted) define a characteristic setting position 29 as described above, which on the one hand is easily optically readable (in particular in automated and/or computer-permitted fashion) and which is specifically characteristic of a particular product form/product type of the insert.

The outlet side 4 may correspond to an end side of the housing 2.

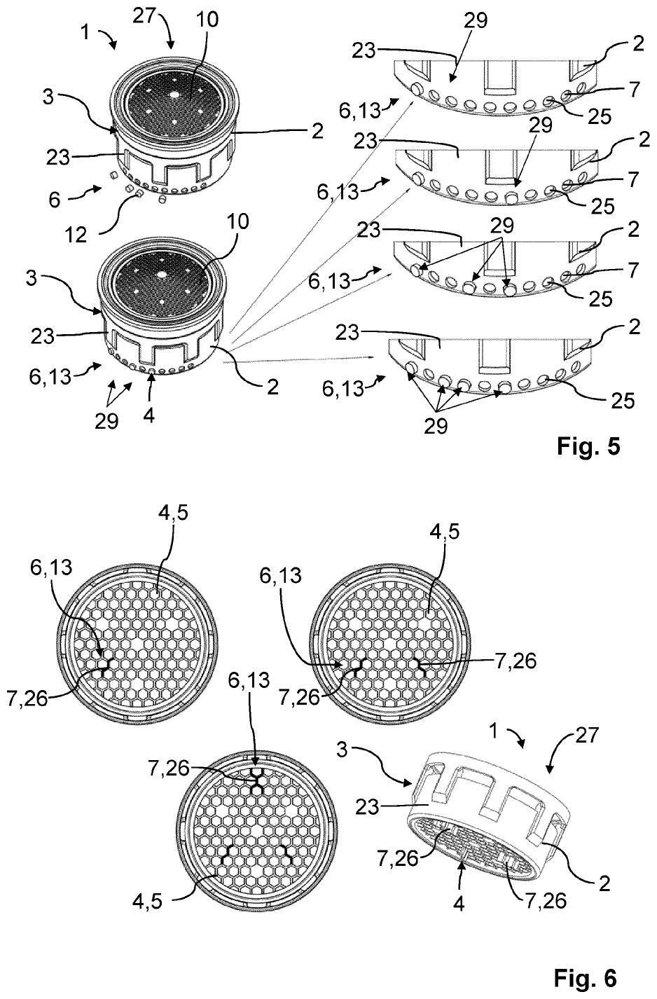

The design variant shown in FIG. 5 is similar to the embodiment shown in FIG. 4, with the plug-in elements 12 in this case being inserted not into the outlet side 4 or the outlet structure 5 but into a side wall 23, in particular a lateral surface, of the housing 2. For this purpose, multiple openings and/or recesses 25 are formed on the housing, into which openings and/or recesses the plug-in elements 12 can be inserted, in particular during the production of the sanitary insert 1.

FIG. 6 again shows a sanitary insert in which the identifier elements 7 that form the identifier 6 are arranged as ribs 26 on the outlet side 4. The identifier elements 7 formed as ribs 26 may for example be formed as elongations of the boundaries between two passage openings 18 of the outlet structure 5. The ribs 26 may furthermore have several directional changes, such that an identification is possible for example from the number of directional changes and/or the number of ribs 26 and/or the position of the ribs 26 and/or the color of the ribs 26.

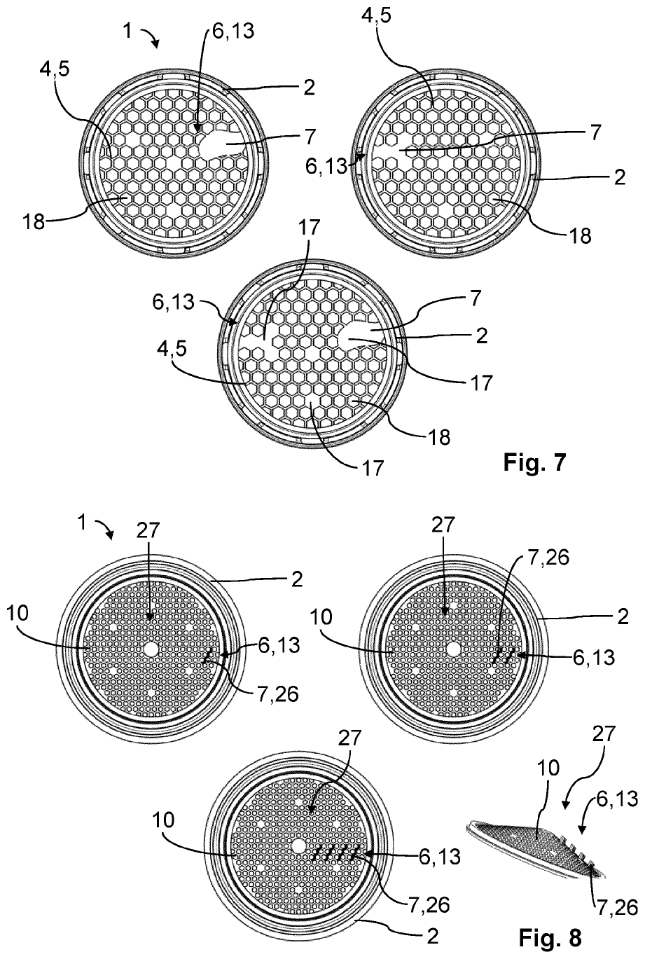

FIG. 7 shows a sanitary insert 1 with one or more fillings 17 of individual and/or several passage openings 18. The fillings 17 may completely and/or only partially close the passage openings 18. Particular product-form-specific patterns 13 can be formed on the outlet side 4 by means of the fillings 17.

FIG. 8 shows a sanitary insert 1, with the identifier 6 in this case being formed on an outlet side 27 of the sanitary insert 1. In the design variant shown, the identifier 6 is formed on a screen 10. The identifier elements 7 are in this case in the form of ribs 26 and protrude from a top side of the screen 10. It is thus possible, for example, for three-dimensional patterns 13 to be formed by means of the identifier elements 7, wherein a pattern form and/or position and/or number of the ribs 26 may vary in a manner dependent on the respective product form.

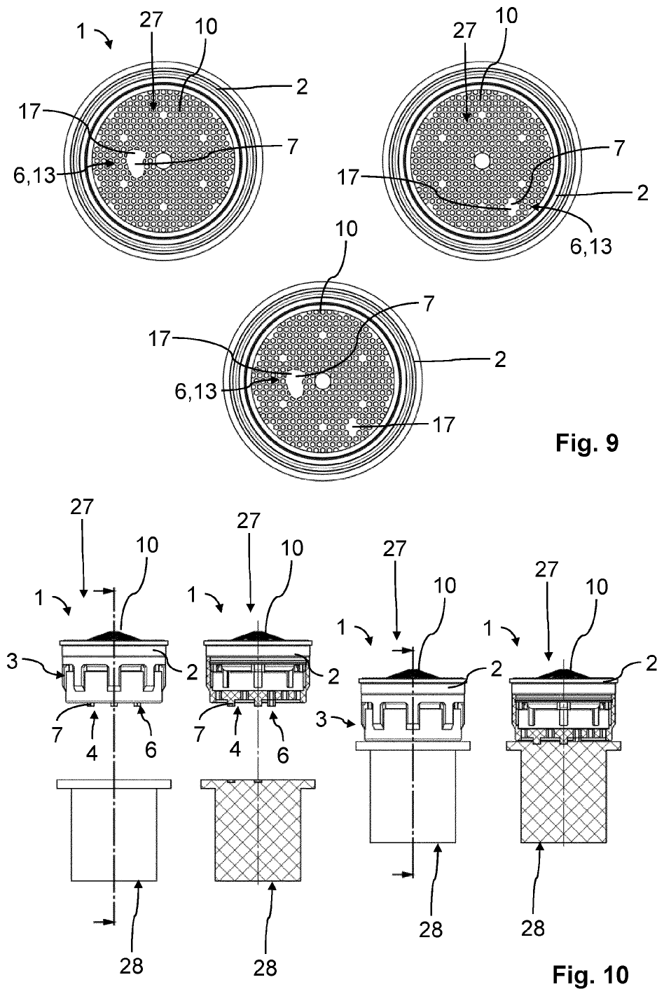

FIG. 9 shows a sanitary insert 1 with one or more fillings 17 of individual and/or several openings of a screen 10 arranged or formed on the inlet side 27. The fillings 17 may completely or only partially close the openings. Particular product-form-specific patterns 13 can be formed on the inlet side 27 by means of the fillings 17.

FIG. 10 shows a sanitary insert 1 with an identifier 6 formed from three-dimensional identifier elements 7 that protrude from the outlet side 4. The identifier elements 7 form a three-dimensional positive, in particular in the form of a height profile and/or a relief, which can be introduced into a detection tool 28. The detection tool 28 may for example comprise a receptacle containing a deformable molding compound. By pressing the positive in the manner of a punch into the molding compound, it is possible to form a negative. By fitting a matching positive into the molded negative, a user can identify a suitable replacement insert 1, because only this can be inserted in a fitting manner into the negative. Non-matching inserts 1, which for example have a different functional unit 3, cannot be introduced in fully fitting fashion into the negative.

It is however also possible to provide the sanitary insert 1 as a set together with a matching detection tool 28. Only a structurally identical replacement insert 1 can then be inserted in a fitting manner into the pre-formed detection tool 28 with the matching negative. The detection tool 28 thus has a pre-formed negative that matches the positive of the insert 1. Non-matching inserts 1 therefore do not constitute suitable replacement parts.

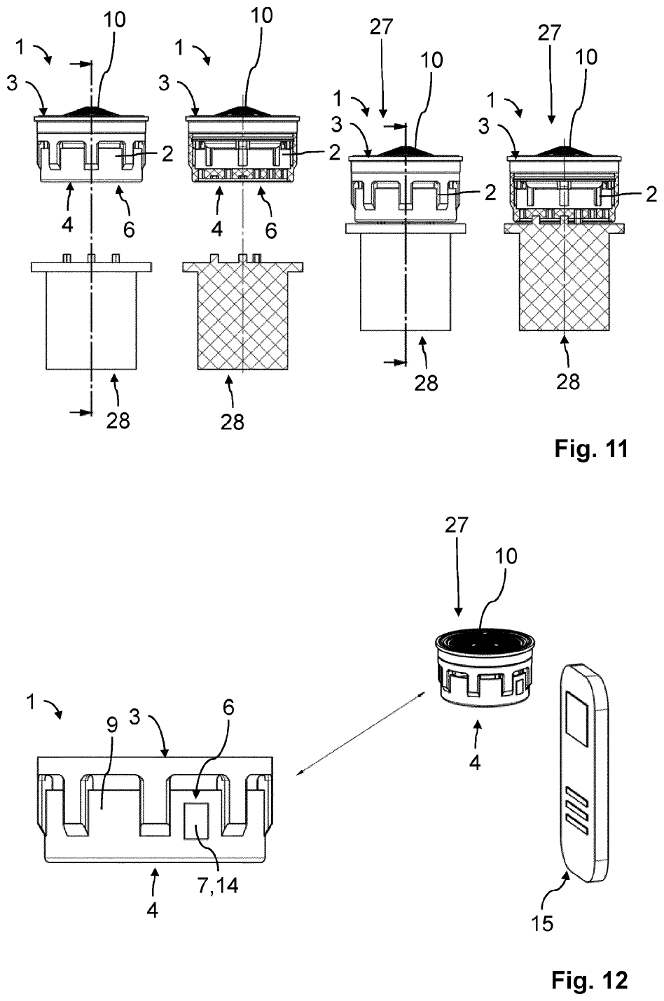

The design variant from FIG. 11 substantially corresponds to the sanitary insert 1 as per FIG. 12, with the positive being formed here not by identifier elements 7 that protrude from the outlet side, the identifier elements 7 of the positive instead being formed by indentations and/or material recesses 22. Correspondingly, the negative of the detection tool 28 has counterpart elements 29 which match the identifier elements 7 and which can be introduced into the identifier elements 7 if these belong to a structurally identical matching replacement part 1.

FIG. 12 shows a sanitary insert 1 with a transponder 14 as identifier 6, such that contactless identification of the structural form is possible using a suitable read unit 15. The detection may be performed here for example by means of near-field communication (NFC) if the identifier element 7, in the form of a transponder 14, is configured for example as an NFC transponder and/or RFID chip. Identifying the structural form using near-field communication has the advantage that the sanitary insert 1 does not even have to be uninstalled from the fitting for this purpose.

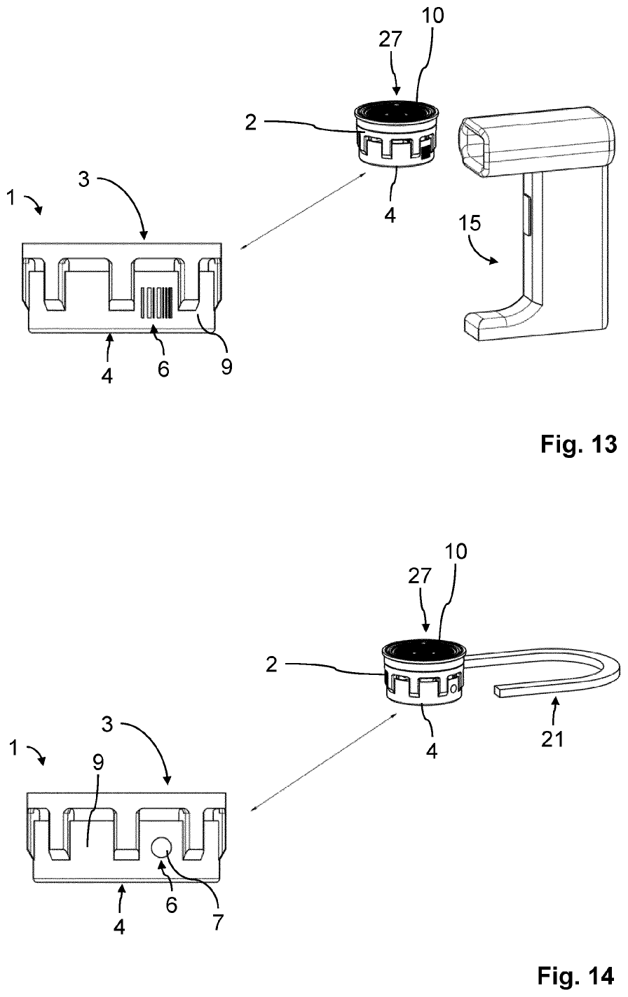

FIG. 13 shows a sanitary insert 1 with a code 16 as identifier 6. The code 16 may be one-dimensional and/or two-dimensional and/or three-dimensional. In particular, it may be a QR code. Using a read unit 15 configured for example as a scanner, the code can be scanned and/or translated, such that the product form of the sanitary insert 1 is output to a user as a result.

FIG. 14 shows a design variant of a sanitary insert 1 with a ferromagnetic identifier 6 that can be read and/or activated by means of a magnet 21. For example, at least one ferromagnetic identifier element 7 may lead to an interaction with the magnet 21. Based on the nature of the interaction, the user can draw conclusions regarding the product form of the sanitary insert 1. The ferromagnetic detection of the identifier 6 may occasionally also be performed when the insert 1 is in the installed state. The sanitary insert 1 thus remains functional during the detection of the identifier 6.

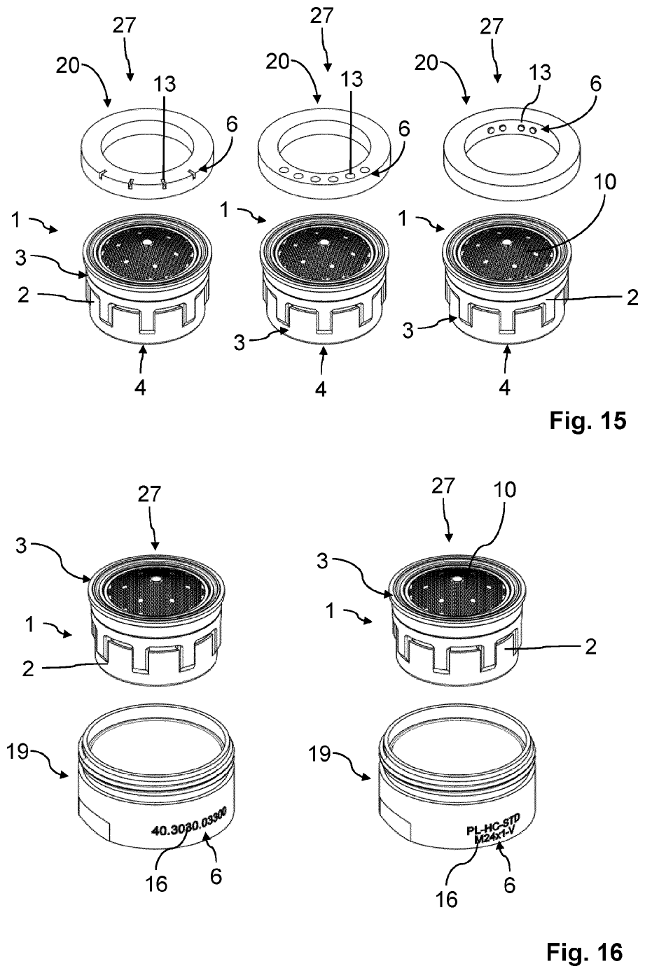

The various design variants of the sanitary insert 1 shown in FIG. 15 each have different identifiers 6, which are formed on a seal 20 that is arranged or arrangeable on the inlet side 27. From the nature of the identifier 6 on the seal 20, formed for example by identifier elements configured as indentations, material recesses and/or material accumulations, conclusions can thus be drawn regarding the respective product form of the sanitary insert 1.

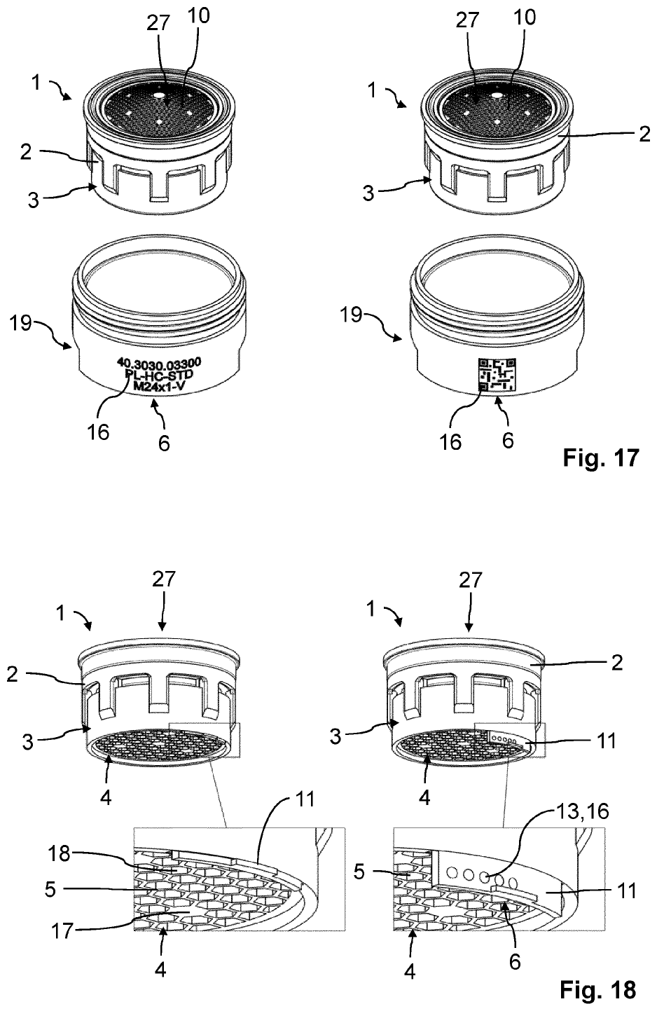

FIGS. 16 and 17 show design variants of the sanitary insert 1, which have a mouth piece 19 into which the sanitary insert 1 is insertable and by means of which the insert 1 is fastenable to an outlet of a fitting. For this purpose, the mouth piece 19 has a coupling point that is connectable to a corresponding counterpart coupling point on the outlet fitting. In particular, the coupling point may be configured as a thread, in particular as an external thread. The at least one identifier 6 is in this refinement formed and/or printed on the outer side of the mouth piece 19. For example, it may be a code 16, in particular clear text and/or a graphical and/or two-dimensional code, such as a QR code.

FIG. 18 shows a design variant of a sanitary fitting 1 with an identifier object 11 which can be removed or pivoted out from the housing 2 and/or from the outlet side 4 and which has the at least one identifier 6. The identifier object 1 can be pulled in an axial direction out of a slide-in compartment in order that, in the pulled-out state, the identifier 6 can be read. The sanitary insert 1 thus remains functional during the detection of the identifier 6. In the inserted state, only an engagement surface, for example for a fingernail or a tool, in particular in the form of a projection, is visible, because the rest of the identifier object 11 is recessed in the slide-in compartment.

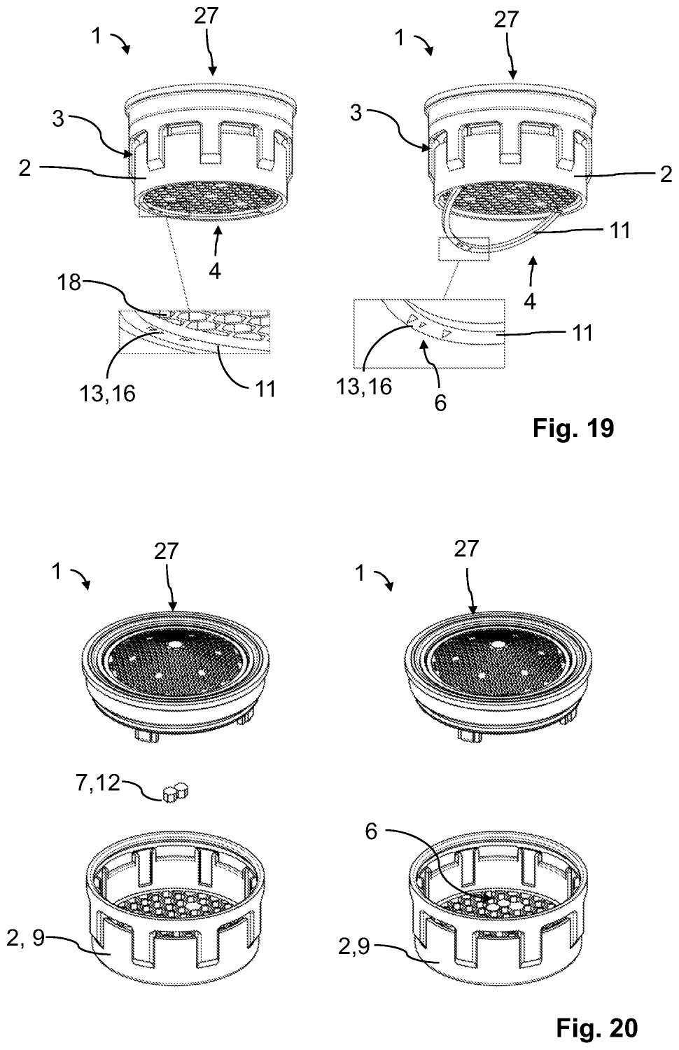

FIG. 19 likewise shows a design variant of a sanitary insert 1 with an identifier object 11 which can be removed or pivoted out from the housing 2 and/or from the outlet side 4 and which has the identifier 6. By contrast to the refinement from FIG. 18, the identifier object 11 is in this case pivotable about an axis of rotation at the outlet side 4. In the pivoted-out state, the user can more easily read the identifier object 11, in particular whilst the insert 1 is in the installed state, and/or can remove the identifier object 11 from the housing 2. The sanitary insert 1 thus remains functional during the detection of the identifier 6. The identifier object 11 may for example be configured as a ring segment.

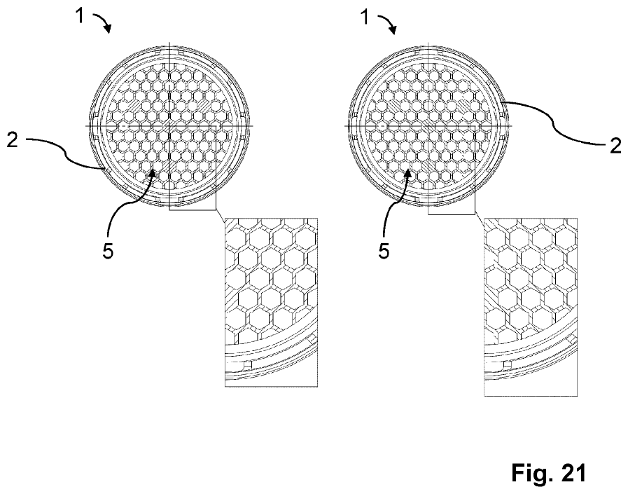

FIG. 20 shows a design variant of a sanitary insert 1 in which identifier elements 7 have been inserted into the outlet structure 5 as plug-in elements 12 in a particular pattern and/or a particular number in accordance with a particular product form. By contrast to FIG. 4, the plug-in elements 12 are in this case inserted not from below, counter to the flow direction, but from above, or from the inside, in the flow direction.

In particular, it is possible in this case, too, for a passage opening 18 to be closed by a plug-in element 12 such that a filling 17 is formed. By means of a particular arrangement of the identifier elements 7 in the outlet structure 5, an identifier 6 assignable to a particular product type can thus be formed.

FIG. 21 shows a further exemplary embodiment according to the invention. The illustration shows two sanitary inserts 1 in which different identifiers—illustrated by way of example using different hatching—are configured in the form of color codings on the respective outlet structure 5. The insets in the Figure each show the detail indicated. The color codings are selected here such that they can be acquired and distinguished automatically. Alternatively or in addition, a color coding may also be implemented on the housing 2.

### LIST OF REFERENCE DESIGNATIONS

1 Sanitary insert
2 Housing
3 Functional unit
4 Outlet side
5 Outlet structure
6 Identifier
7 Identifier element
8 Identifier ring
9 Housing part
10 Screen
11 Identifier object
12 Plug-in element
13 Pattern
14 Transponder
15 Read unit
16 Code
17 Filling
18 Passage opening
19 Mouth piece
20 Seal
21 Magnet
22 Material recess
23 Side wall
24 Material accumulation
25 Opening; recess
26 Rib
27 Inlet side
28 Detection tool
29 Setting position (between 7)

1. A sanitary insert (1), comprising:
a housing (2);
at least one functional unit (3) arranged in the housing, the at least one functional unit having an outlet side (4), which is formed by an outlet structure (5); and
at least one discernible identifier (6) by which a product form of the sanitary insert (1) is identifiable.

2. The sanitary insert (1) as claimed in claim 1, wherein the at least one discernible identifier (6) comprises at least two identifier elements (7) which are at least one of adjustable or fixable in position relative to one another, and a specific said discernible identifier (6) is settable or set by setting a particular position of the two identifier elements (7) with respect to one another.

3. The sanitary insert (1) as claimed in claim 2, wherein the at least two identifier elements (7) are adjustable relative to one another at least one of during production of the insert (1) or subsequently, into a setting position (29) that characterizes the insert (1) or a particular product form thereof, and the setting position (29) thus set is subsequently permanently fixable, and thus allows unique identification of the insert, when the insert (1) is in an intended position of use.

4. The sanitary insert (1) as claimed in claim 1, further comprising an identifier object (11) which is removable or pivotable out from at least one of the housing (2) or from the outlet side (4) and which has the at least one identifier (6).

5. The sanitary insert (1) as claimed in claim 1, wherein the at least one identifier (6) is arranged such that the at least one identifier (6) is detectable when the sanitary insert (1) is in an installed state in a sanitary fitting.

6. The sanitary insert (1) as claimed in claim 1, wherein the at least one identifier (6) is formed by at least one plug-in element (12), the at least one plug-in element (12) being at least one of plugged onto or into the outlet structure (5), or into the housing (2), and a pattern (13) that forms the at least one identifier (6) is formed by multiple plug-in elements (12).

7. The sanitary insert (1) as claimed in further comprising a transponder (14) in which the at least one identifier (6) is stored, the at least one identifier (6) being readable using a reader (15).

8. The sanitary insert (1) as claimed in claim 1, wherein the at least one identifier (6) is formed as at least one of a two-dimensional or three-dimensional code (16).

9. The sanitary insert (1) as claimed in claim 1, wherein the at least one identifier (6) is at least one of arranged or formed on at least one of: the outlet side (4), a pattern (13) of fillings (17) of passage openings (18) of the outlet structure (5), an upstream screen (10), a mouth piece (19), a seal (20), or the housing (2).

10. The sanitary insert (1) as claimed in claim 1, further comprising at least one magnetically readable identifier (6) by means of which a product form of the sanitary insert (1) can be identified.

11. A method for producing a sanitary insert (1), having at least one of an optically or magnetically discernible identifier (6) for identifying a product form of the sanitary insert (1), the method comprising:
forming the identifier (6) using at least two identifier elements (7) which are adjustable relative to one another
adjusting the identifier elements (7) relative to one another and fixing the identifier elements relative to one another in a setting position that characterizes the insert (1) or a product form thereof.

12. The method as claimed in claim 11, further comprising, to form the at least one identifier (6), plugging at least one plug-in element (12) into at least one of the housing (2) or an outlet structure (5).

13. A method for identifying a product form of a sanitary insert (1), the method comprising:
acquiring at least one discernible identifier (6) assigned to the product form on the sanitary insert (1);
determining the product form using the acquired at least one identifier (6) based on an identifier list stored in a database; and
at least one of outputting the product form or sorting the insert (1) in accordance with the product form.

14. The method as claimed in claim 13, further comprising at least one of removing or pivoting out from the housing or an outlet side of the sanitary insert an identifier object (11) which has the at least one discernible identifier (6), and identifying the product form from the identifier (6) on the identifier object (11).

15. The method as claimed in claim 14, wherein the at least one identifier (6) is coded on the identifier object (11) so as to be machine-readable.

16. The method as claimed in claim 13, wherein the acquiring includes at least one of: optical detection, near-field communication, haptic detection, detection by positive engagement, magnetic detection and electromagnetic detection for detecting the identifier (6).

17. The method as claimed in claim 13, wherein the acquiring of, the at least one identifier (6) includes taking a negative molding, or using a provided negative, and comparing the negative with an identifier list that comprises positives.

18. A computer program product, comprising commands fixed in a tangible storage medium which, when the program is executed by a computer, cause said computer to carry out a method as claimed in claim 13.

19. A device, comprising a processor programmed with steps of the method as claimed in claim 13.

20. A computer-readable memory medium, comprising commands fixed in a tangible medium which, when executed by a computer, cause said computer to carry out the method as claimed in claim 13.
